(19) United States
(12) Patent Application Publication
(10) Pub. No.: US 2010/0070990 A1
(43) Pub. Date: Mar. 18, 2010

(54) RECEPTION DEVICE, CONTROL METHOD, AND PROGRAM

(75) Inventor: Keisuke Nagumo, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SONY CORPORATION, Tokyo (JP)

(21) Appl. No.: 12/309,942

(22) PCT Filed: Aug. 3, 2007
(86) PCT No.: PCT/JP2007/065226

§ 371 Date: Nov. 10, 2009

(30) Foreign Application Priority Data
Aug. 3, 2006 (JP) 2006-212424

(51) Int. Cl. H04N 7/16

(52) U.S. Cl. 725/30

(57) ABSTRACT

The present invention relates to a reception device, a control method, and a program that are configured to surely restrict an operation that can be executed by each user. Operating user identification block 142 identifies, on the basis of user identifier for identifying a user, an operating user who operates operation means to be operated by a user without password entry by a user. Restriction control block 145 determines, on the basis of the yes/no operation information, related with the user identifier for identifying the operating user, indicating restricted/permitted operation of restricting or permitting the operation of the operating user, whether an operation of the operation means by the operating user is a restricted/permitted operation. Further, the restriction control block 145 restricts or permits processing to be executed in accordance with an operation of the operation means by the operating user if the operation of the operation means by the operating user is found to be a restricted/permitted operation. The present invention is applicable to a television receiver, for example.

### TECHNICAL FIELD

The present invention relates generally to a reception device, a control method, and a program and, more particularly, to a reception device, a control method, and a program that are configured to surely restrict an operation that can be executed by each user.

### BACKGROUND ART

For example, operations to be executed on a television receiver include those operations which are restricted to particular users, such as operation of setting and clearing the viewing restriction of restricting viewing of predetermined programs according to user age, in addition to those operations which are not restricted to particular users, such as channel switching and the setting of picture quality and tone quality.

Therefore, if, with television receivers, an operation restricted to be executed by a particular user has been executed the user who has done that operation (namely, the operating user) is demanded for entering a password of that user. Further, with television receivers, if the authentication that the user who entered the password is the user who is permitted to execute an operation restricted to particular users fails, the operation by that operating user is restricted.

On the other hand, if the authentication is successful with television receivers, the operation by the operating user is not restricted and the processing corresponding to that operation is executed.

For a technology for restricting an operation by particular users as described above, Patent Document 1 (especially, refer to paragraph [0021] and [0022] of Patent Document 1) discloses one that a user enters fingerprint information of his own by use of a fingerprint input device for entering fingerprint information into a television receiver and, if the user is certified to be a setting person who can set viewing restrictions, the restriction of viewing by other users, for example.

It should be noted that a technology is disclosed in Patent Document 2 (especially, refer to paragraph through paragraph [0052] and FIG. 15 of Patent Document 2) in which a user-unique remote command is prepared for each user and access is restricted to only the image data related to the identification information for user identification transmitted from the remote commander operated by the user.

In addition, a technology is disclosed in Patent Document 3 (especially, refer to paragraph [0020] of Patent Document 3) in which, if a user viewing a television receiver satisfies a user condition that is a condition for accessing the user information associated with the user, the user is permitted to access the user information.

### Patent Document 1: Japanese Patent Laid-Open No. 2001-86479

### Patent Document 2: Japanese Patent Laid-Open No. 2005-64757

### Patent Document 3: Japanese Patent Laid-Open No. 2002-288135

### DISCLOSURE OF INVENTION

### Technical Problem

Meanwhile, as described above, with television receivers in which a user operation is restricted by password authentication, by considering that any operation restricted by password cannot be executed if a user forgets his password, the initializing operation for initializing a state (setting) of the television receiver to an initial state in which operations are not restricted by password is not restricted by password.

Therefore, if the user forgets his password, the user can execute any operations by executing an initializing operation that is not restricted by password.

However, the initializing operation not restricted by password can be executed by any user, so that, by executing the initializing operation, any user can subsequently execute any operation.

It should be noted that Patent Document 1 discloses a technology for restricting an operation for setting restriction to the viewing by other users. Further, Patent Document 2 and Patent Document 3 disclose technologies for restricting access to image data and user information. However, none of Patent Document 1 through Patent Document 3 discloses any initializing operation.

It is therefore an object of the present invention to surely restricting operations that can be executed for each user.

### Technical Solution

In carrying out the invention and according to one aspect thereof, there is provided a reception device for receiving television broadcast. The reception device has storage means for storing user identifier for identifying a user and yes/no operation information indicative of a restricted/permitted operation that is restricted or permitted for a user identified by that user identifier, the user identifier and the yes/no operation information being related with each other; identification means for identifying, on the basis of the user identifier, an operating user who operates operation means to be operated by a user without password entry; decision means for determining, on the basis of the yes/no operation information related with the user identifier for identifying the operating user, whether an operation of the operation means by the operating user is a restricted/permitted operation; and processing control means for restricting or permitting processing to be executed in accordance with an operation of the operation means by the operating user if the operation of the operation means by the operating user is found by the decision means to be a restricted/permitted operation, wherein the restricted/permitted operation includes an initializing operation for putting the yes/no operation information into an initial state indicative that all operations of the operation means are not restricted or an initial state indicative that all operations of the operation means are permitted.

The storage means can store the user identifier and the yes/no operation information as related with each other in accordance with an operation of the operation means.

One aspect of the reception device may be a television receiver.

The storage means can store the user identifier and setting information indicative of setting of the reception device customized for a user identified by that user identifier, the user identifier and the setting information being further related with each other and the reception device can further have setting control means for set the setting of the reception device to the setting customized for the operating user on the basis of the setting information related with the user identifier for identifying the operating user.

In carrying out the invention and according to another aspect thereof, there is provided a control method or a program for controlling a reception device for receiving television broadcast. The control method or a program has the steps of: identifying, on the basis of user identifier stored in storage means, an operating user who operates operation means to be operated by a user without password entry; the storage means storing the user identifier for identifying a user and yes/no operation information indicative of a restricted/permitted operation that is restricted or permitted for a user identified by that user identifier, the user identifier and the yes/no operation information being related with each other; determining, on the basis of the yes/no operation information related with the user identifier for identifying the operating user, whether an operation of the operation means by the operating user is a restricted/permitted operation; and restricting or permitting processing to be executed in accordance with an operation of the operation means by the operating user if the operation of the operation means by the operating user is found to be a restricted/permitted operation, wherein the restricted/permitted operation includes an initializing operation for putting the yes/no operation information into an initial state indicative that all operations of the operation means are not restricted or an initial state indicative that all operations of the operation means are permitted.

In one aspect of the present invention, an operating user who operates operation means that is operated by a user is identified without password entry by a user on the basis of user identifier for identifying a user and it is determined, on the basis of yes/no operation information, being related with the user identifier for identifying the operating user, indicative of a restricted/permitted operation for restricting or permitting the above-mentioned operating user, whether an operation of the above-mentioned operation means by the above-mentioned operating user is a restricted/permitted operation. In addition, if the operation of the above-mentioned operation means by the above-mentioned operating user is found to be a restricted/permitted operation, then processing to be executed in accordance with the operation of the above-mentioned operation means by the above-mentioned operating user is restricted or permitted.

### ADVANTAGEOUS EFFECTS

According to the present invention, operations that can be executed can be surely restricted for each user.

### BRIEF DESCRIPTION OF DRAWINGS

FIG. 1 is a block diagram illustrating an exemplary configuration of a television receiver system practiced as one embodiment of the invention.

FIG. 2 is a diagram illustrating an example of a user information list stored in a nonvolatile memory 62 shown in FIG. 1.

FIG. 3 is a diagram illustrating an example of yes/no operation information shown in FIG. 2.

FIG. 4 is a block diagram illustrating an exemplary functionally configuration of a main microcomputer 65 shown in FIG. 1.

FIG. 5 is a flowchart indicative of an operating user identification information for identifying an operating user.

FIG. 6 is a flowchart indicative of operation restriction processing for restricting an operation by an operating user.

### EXPLANATION OF REFERENCE NUMERALS

11: Television receiver, 13: Remote commander, 31: User identifier output block, 62: Nonvolatile memory, 63: Operator unit, 65: Main microcomputer, 100: User information storage block, 142: Operating user identification block, 145: Restriction control block, 147: Key event processing block, 148: Setting information control block

### BEST MODE FOR CARRYING OUT THE INVENTION

This invention will be described hereinbelow with reference to the accompanying drawings.

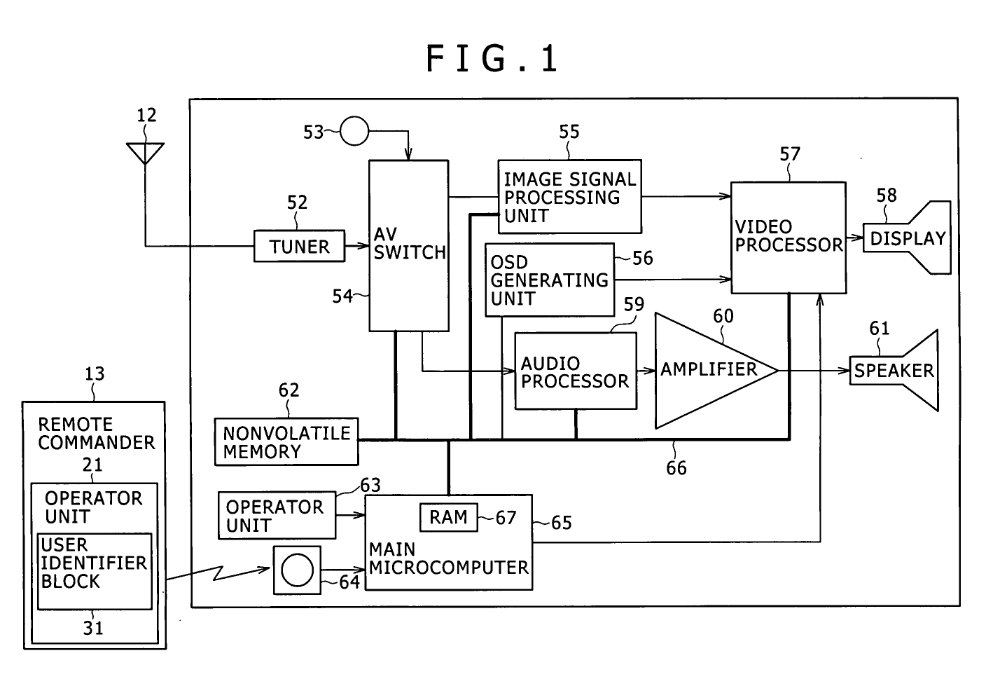

FIG. 1 is a block diagram illustrating an exemplary configuration of one embodiment of a television receiver system to which the present invention is applied.

The television receiver system shown in FIG. 1 is configured by a television receiver 11, an antenna 12, and a remote commander 13.

The television receiver 11 shown in FIG. 1 is configured by a tuner 52, a video input terminal 53, an AV switch 54, an image signal processing unit 55, an OSD (On Screen Display) generation unit 56, a video processor 57, a display 58, an audio processor 59, an amplifier 60, a speaker 61, a nonvolatile memory 62, an operator unit 63, a remote commander reception unit 64, a main microcomputer 65, and an IIC (Inter Integrated Circuit) bus 66.

The tuner 52 demodulates a broadcast signal of a predetermined channel of broadcast signals supplied from the antenna 12 and supplies resultant composite video signal and audio signal to the AV switch 54.

The video input terminal 53 is a terminal in which a composite video signal and an audio signal supplied from a reproducing device not shown are entered, the entered composite video signal and audio signal being further supplied to the AV switch 54.

The AV switch 54 selects the composite video signal and audio signal of the composite video signal and audio signal supplied from the tuner 52 or the composite video signal and audio signal supplied from the video input terminal 53.

Also, the AV switch 54 supplies the selected composite video signal to the image signal processing unit 55 and the selected audio signal to the audio processor 59.

The image signal processing unit 55 converts the composite video signal supplied from the AV switch 54 into a luminance signal and a color difference signal, which are supplied to the video processor 57.

The OSD generation unit 56 generates a GUI (Graphical User Interface) such as a menu screen and an OSD image that is an image to be displayed in OSD onto the display 58 and appropriately supplies the generated images to the video processor 57.

The video processor 57 converts the luminance signal and color difference signal supplied from the image signal processing unit 55 into an RGB signal and supplies a content image corresponding to this RGB signal to the display 58 for display.

Also, if an OSD image is supplied from the OSD generation unit 56, the video processor 57 superimposes (composes) the OSD image supplied from the OSD generation unit 56 with the content image corresponding to the RGB signal and supplies the resultant composite image to the display 58 for display.

The display 58, configured by a CRT (Cathode Ray Tube) or LCD (Liquid Crystal Display), for example, displays images supplied from the video processor 57.

The audio processor 59 adjusts the tone quality and so on of an audio signal supplied from the AV switch 54 and supplies the adjusted audio signal to the amplifier 60.

The amplifier 60 amplifies the audio signal supplied from the audio processor 59 and supplies the amplified audio signal to the speaker 61.

The speaker 61 outputs the voice (tone) corresponding to the audio signal supplied from the amplifier 60.

The nonvolatile memory 62, configured by an EEPROM (Electrically Erasable Programmable Read Only Memory) for example, stores programs that are executed by the main microcomputer 65 and various kinds of data that are used by the processing by the main microcomputer 65.

It should be noted that the various data include user information. The user information denotes information, such as user ID (IDentification) of a user who operates the television receiver 11, operating user information indicative whether the user is operating the television receiver 11 or not, user identification information for identifying the operating user who is the user to operate the television receiver 11, yes/no operation information indicative of restricted/permitted operation for restricting or permitting the user identified by the user identification information, and setting information indicative of the setting of the television receiver 11 customized for the user identified by the user identification information, these items of information being related to each other.

The operator unit 63, operated by the user, supplies an operation signal corresponding to an operation done by the user through the operator unit 63 to the main microcomputer 65.

The remote commander reception unit 64 receives a wireless operation signal radiated from the remote commander 13 and supplies the received signal to the main microcomputer 65.

The main microcomputer 65 is a general-purpose or dedicated built-in microcomputer and controls the AV switch 54, the image signal processing unit 55, the OSD generation unit 56, the video processor 57, and the audio processor 59 via the IIC bus 66.

Namely, the main microcomputer 65, incorporating a RAM (Random Access Memory) 67, uses this RAM as a work area to execute a predetermined program stored in the nonvolatile memory 62, thereby controlling each block constituting the television receiver 11. In addition, the main microcomputer 65 executes processing in accordance with an operation signal supplied from the operator unit 63 or the remote commander reception unit 64.

It should be noted that a drive not shown can be connected to the television receiver 11. Programs to be executed by the main microcomputer 65 are installed into the nonvolatile memory 62 from a removable media such as a magnetic disk, an optical disk, a magneto-optical disk, or a semiconductor memory loaded on this drive. Also, programs to be executed by the main microcomputer 65 can be installed into the nonvolatile memory 62 by downloading these programs from a server for example on the Internet via a communication interface not shown.

The antenna 12 receives a broadcast wave that is a radio wave and supplies a broadcast signal that is an electrical signal obtained as a result to the tuner 52.

The remote commander 13 has an operator unit 21 that is operated by the user and, when the user operates the operator unit 21, radiates an operation signal for example corresponding to the operation done by the user through the operator unit 21 to the remote commander reception unit 64 in a wireless manner such as infrared ray.

The operator unit 21 of the remote commander 13 has operations keys such as a menu display button for displaying a menu and a volume button for varying volume. Further, the operator unit 21 has a user identifier output block 31 for outputting a user identifier for identifying the user operating the operator unit 21.

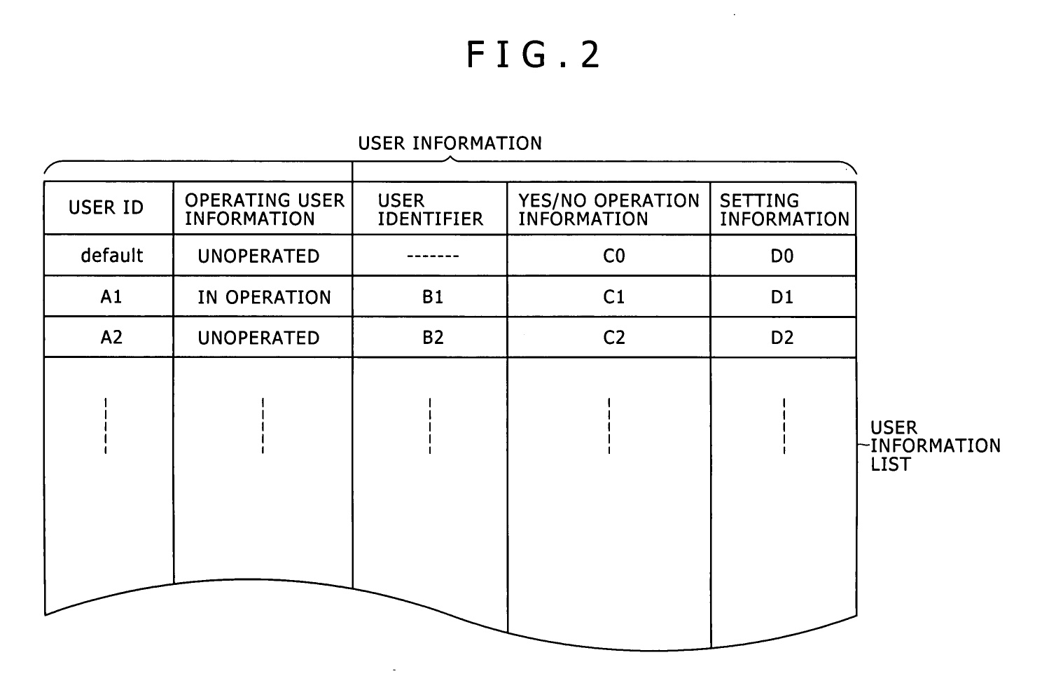

Referring to FIG. 2, there is shown a diagram illustrating a user information list that is a list of user information stored in the nonvolatile memory 62.

In the user information list shown in FIG. 2, user information in which user ID, operating user information, user identifier, yes/no operation information, and setting information are correlated is registered in one row.

Namely, in the user information list, user ID of the user information is registered in the first column (range) from the left. Here, user ID is determined by the television receiver 11 in accordance with an operation by the user through the remote commander 13 or the operator unit 63 when user information is registered in the user information list.

In the second column from the left of the user information list, operating user information indicative whether the user indicated by the user ID in the first column from the left is operating the television receiver 11 is registered.

In the third column from the left of the user information list, user identifier for identifying the user indicated by the user ID is registered without entering the password by the user. Here, for the user identifier, fingerprint information obtained from the fingerprint of the thumb or index finger of the user, iris information obtained from the iris of the user, or vein information obtained from the vein state of the user can be employed.

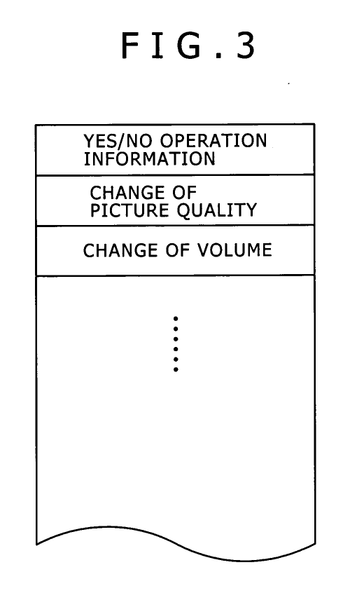

Further, in the fourth column from the left of the user information list, yes/no operation information indicative of a restricted operation for restricting an operation of the user is registered. It should be noted that the yes/no operation information will be detailed later with reference to FIG. 3.

Also, in the fifth column from the left of the user information list (the first column from the right), setting information indicative of the setting of the television receiver 11 such as picture quality (brightness and so on) and volume, a screen mode (normal mode in which an image is displayed with aspect ratio of 4:3, wide mode in which an image is displayed with aspect ratio of 16:9, and so on) and menu items that are displayed on a menu screen, and so on are registered.

It should be noted that, in FIG. 2, in line 1 of the user information list, user information of a user with user ID being “default” (hereafter appropriately referred to as a default user) is registered. The user identifier of the user information of the default user is not registered, so that any user who cannot be identified by the user identifier of the user information other than the user information of a default user is handled as a default user.

Also, the user information list is in a state where only the user ID of a default user is registered in an initial state to be described later. Immediately after purchase of the television receiver 11, the user information list is in the initial state or, if the user not restricted for an initializing operation has executed an initializing operation through the remote commander 13 or the operator unit 63, the user information also gets in the initial state.

The following describes an example of the yes/no operation information shown in FIG. 2 with reference to FIG. 3.

In the yes/no operation information shown in FIG. 3, information about a restricted operation that is an operation that the user is restricted to execute is registered.

Therefore, if the user indicated by the user ID related with the yes/no operation information shown in FIG. 3 operates the television receiver 11, the user is restricted to execute an operation of changing the picture quality registered in the first row of yes/no operation information and changing of volume registered in the second row shown in FIG. 3 and is permitted to execute only operations other than the restricted operations registered in the yes/no operation information shown in FIG. 3.

Here, the restricted operations include an initializing operation that puts the yea/no operation information into an initial state indicative that all operations are not restricted. Further, included in the restricted operations are an operation (yes/no operation information registering operation) for registering various operations including an initialing operation as restricted operations to the yes/no operation information and an operation (yes/no operation information clearing operation) for clearing the registration, as restricted operations, of various operations including an initializing operation.

The initializing operation by the user with the initializing operation registered in yes/no operation information as a restricted operation is restricted. Therefore, the initializing operation can be executed only by a user with the initializing operation not registered in yes/no operation information as a restricted operation.

Likewise, a yes/no operation information registering operation by the user with a yes/no operation information registering operation registered in yes/no operation information as a restricted operation is also restricted. Therefore, yes/no operation information registering operation can be executed only by the user with a yes/no operation information registering operation not registered in yes/no operation information as a restricted operation.

Also, a yes/no operation information clearing operation by a user with a yes/no operation information clearing operation registered in yes/no operation information as a restricted operation is restricted. Therefore, a yes/no operation information clearing operation can be executed only by a user with a yes/no operation information clearing operation not registered in yes/no operation information as a restricted operation.

The main microcomputer 65 shown in FIG. 1 executes various processing operations by use of the user information list described with reference to FIG. 2 and FIG. 3.

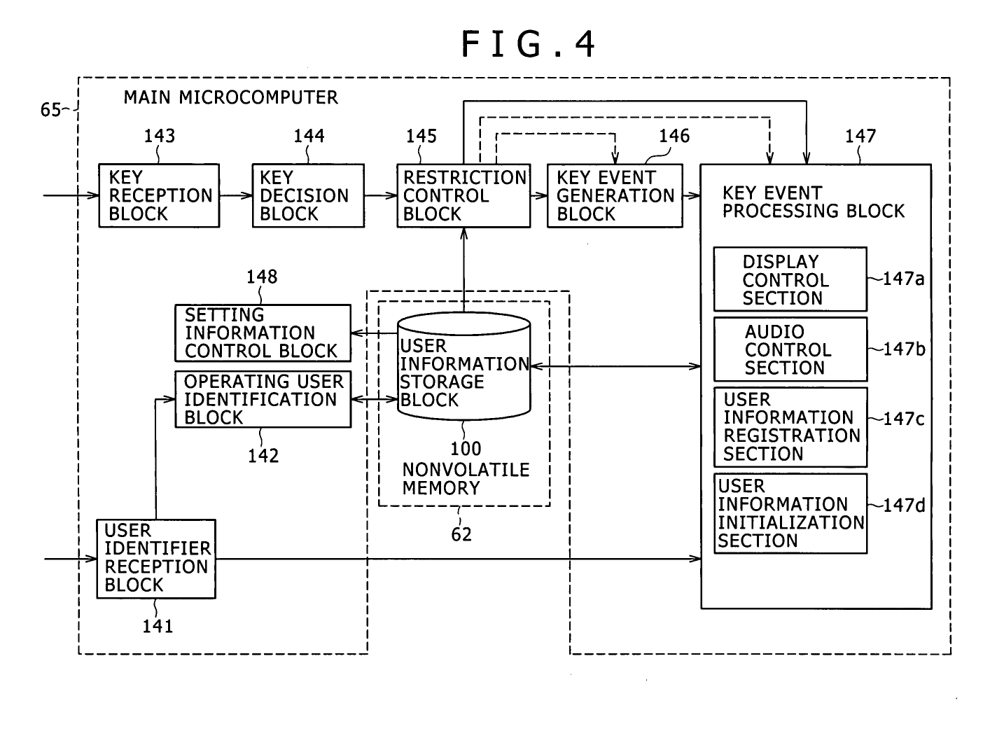

Namely, FIG. 4 is a block diagram illustrating an exemplary functional configuration of the main microcomputer 65 that is realized by the execution of a predetermined program by the main microcomputer 65.

The main microcomputer 65 has a user identifier reception block 141, an operating user identification block 142, a key reception block 143, a key decision block 144, a restriction control block 145, a key event generation block 146, a key event processing block 147, and a setting information control block 148.

It should be noted that, in FIG. 4, a user information storage block 100 is a part of a storage area of the nonvolatile memory 62 shown in FIG. 1, storing the user information list described above with reference FIG. 2 and FIG. 3.

The user identifier reception block 141 receives user identifier supplied from the operator unit 63 or the remote commander reception unit 64 shown in FIG. 1 and supplies the received user identifier to the operating user identification block 142 or the key event processing block 147.

The operating user identification block 142 identifies an operating user who is operating the remote commander 13 or the operator unit 63 on the basis of the user identifier supplied from the user identifier reception block 141 and, on the basis of the identified operating user, updates the operating user information of a user information list stored in the user information storage block 100.

The key reception block 143 receives an operation signal supplied from the operator unit 63 or the remote commander reception unit 64 shown in FIG. 1 and supplies the received signal to the key decision block 144.

The key decision block 144 determines, on the basis of the operation signal supplied from the key reception block 143, an operation key of the remote commander 13 or the operator unit 63 shown in FIG. 1 operated by the operating user and supplies operation key information that is a decision result to the restriction control block 145.

The restriction control block 145 reads yes/no operation information related to the operating user information indicative that the television receiver 11 is being operated from the user information list stored in the user information storage block 100 and determines on the basis of this yes/no operation information and the operation key information supplied from the key decision block 144 whether the operation of an key operation key by the operating user is a restricted operation or not.

If the operation of an operation key by the user is found to be not a restricted operation, the restriction control block 145 supplies the operation key information supplied from the key decision block 144 to the key event generation block 146.

On the other hand, if the operation of an operation key by the operating user is found to be a restricted operation, the restriction control block 145 executes restriction processing for restricting the processing to be executed in accordance with that operation key and, further, as required, notifies the key event processing block 147 of the restriction of the operation of the operation key by the operating user, commanding the display of the restriction on the display 58 in FIG. 1 in OSD, for example.

The key event generation block 146 generates a key event in accordance with the operation key information supplied from the restriction control block 145 and supplies the generated key event to the key event processing block 147.

The key event processing block 147 executes various processing operations on the basis of the key event supplied from the key event generation block 146 and commands from the restriction control block 145. Namely, the key event processing block 147, configured by a display control section 147a, an audio control section 147b, a user information registration section 147c, and a user information initialization section 147d, executes various processing operations.

The display control section 147a executes control so as to display an OSD image on the display 58. Namely, the display control section 147a controls the OSD generation unit 56 shown in FIG. 1 to generate an OSD image and controls the video processor 57 so as to display this OSD image on the display 58.

Here, an OSD image may be an OSD image of a menu screen or an OSD image of a message indicative that an operation is restricted.

The audio control section 147b controls the audio processor 59 (FIG. 1) in accordance with a key event corresponding to an operation for changing volume and tone quality.

The user information registration section 147c adds, deletes, or changes the user information on a user information list stored in the user information storage block 100 in accordance with a key event corresponding to the operation of adding, deleting, or changing user information.

The user information initialization section 147d initializes a user information list stored in the user information storage block 100 in accordance with a key event corresponding to an initializing operation.

Here, a user information list in the initial state denotes a user information list registered with only the user information of default users as described above and the yes/no operation information of default users at this moment is the yes/no operation information indicative that any operation is not a restricted operation, namely, the yes/no operation information indicative that a default user can execute all operations.

The setting information control block 148 reads setting information related with operating user information indicative that the user is operating the television receiver 11 from a user information list (FIG. 2) stored in the user information storage block 100 and, on the basis of this setting information, controls the AV switch 54, the image signal processing unit 55, the OSD generation unit 56, the video processor 57, and the audio processor 59 shown in FIG. 1. This allows, for each user, the use of the television receiver 11 having different, channel settings for setting a combination of a channel received by the television receiver 11 and a channel number displayed in that channel and different settings of picture quality and volume, and menu items to be displayed on a menu screen.

In the main microcomputer 65 shown in FIG. 4 configured as described above, operating user identification processing is executed so as to identify an operating user who is operating the remote commander 13 or the operator unit 63.

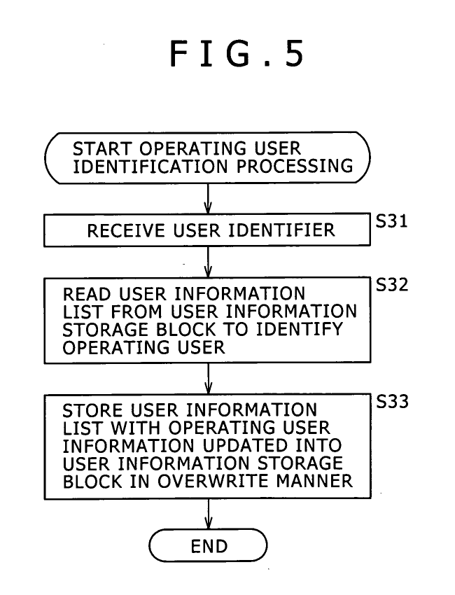

Namely, FIG. 5 shows a flowchart indicative of the operating user identification processing for the television receiver 11 to identify an operating user.

The operating user identification processing starts when a user operates the remote commander 13 or the operator unit 63 shown in FIG. 1 so as to execute the operating user identification processing.

Here, for the brevity of description, the following description will be made paying attention to a case where the user operates the remote commander 13, for example, of the remote commander 13 and the operator unit 63.

When the user holds the remote commander 13 in the hand and operates the remote commander 13 so as to execute the operating user identification processing, the user identifier output block 31 (FIG. 1) of the remote commander 13 detects and outputs user fingerprint information, for example.

Namely, a sensor unit (not shown) for detecting user fingerprint information is arranged at a predetermined location of a housing of the remote commander 13 and, when the user puts the thumb of the right hand or the left hand onto the sensor unit, the user identifier output block 31 detects and outputs user fingerprint information on the basis of the output of the sensor unit.

Then, the remote commander 13 transmits the fingerprint information outputted from the user identifier output block 31, as the user identifier.

The user identifier transmitted by the remote commander 13 is received by the remote commander reception unit 64 shown in FIG. 1 and is supplied from the remote commander reception unit 64 to the user identifier reception block 141 (FIG. 4) of the main microcomputer 65.

In step S31, the user identifier reception block 141 receives the user identifier supplied from the remote commander reception unit 64 and supplies the user identifier to the operating user identification block 142, upon which the procedure goes to step S32.

In step S32, the operating user identification block 142 identifies an operating user by use of a user information list stored in the user information storage block 100 and the user identifier supplied from the user identifier reception block 141.

Namely, the operating user identification block 142 determines whether the user identifier matching the user identifier supplied from the user identifier reception block 141 is found in the user identifier registered in the user information list stored in the user information storage block 100 and, if the user identifier matching the user identifier supplied from the user identifier reception block 141 is found matching, identifies the user indicated by the user ID related with that user identifier as the operating user (the user ID related with that user identifier is identified as the user ID of the operating user).

On the other hand, if no user identifier matching the user identifier supplied from the user identifier reception block 141 is found, the operating user identification block 142 identities a default user as the operating user (the user ID of a default user is identified as the user ID of the operating user).

Then, the procedure goes from step S32 to step S33, in which the operating user identification block 142 updates, in the user information of the user information storage block 100, the operating user information related with the user ID of the operating user to operating user information “in operation” indicative that the television receiver 11 is being operated as the operating user information registered at second row in the user information list shown in FIG. 2.

Also, in the present embodiment, it is assumed that one user operate the remote commander 13 shown in FIG. 1, so that, in step S33, the operating user identification block 142 updates, in the user information of the user information storage block 100, the operating user information related with a user ID of other than the user ID of the operating user to operating user information “unoperated” indicative that the television receiver 11 is not being operated (unoperated) as with the operation user information registered at first row or third row in the user information list shown in FIG. 2, upon which the operating user identification processing ends.

In the operating user identification processing shown in FIG. 5, an operating user is identified without entering the password of a user, so that any situation that a particular operation cannot be executed only due to the forgetting of user identifier by the user can be avoided.

When the operating user has been identified by the operating user identification processing shown in FIG. 5, then, in the television receiver 11, operation restriction processing for restricting the processing in accordance with an operation of the remote commander 13 shown in FIG. 1 is executed on the basis of the yes/no operation information shown in FIG. 3 related with the operating user.

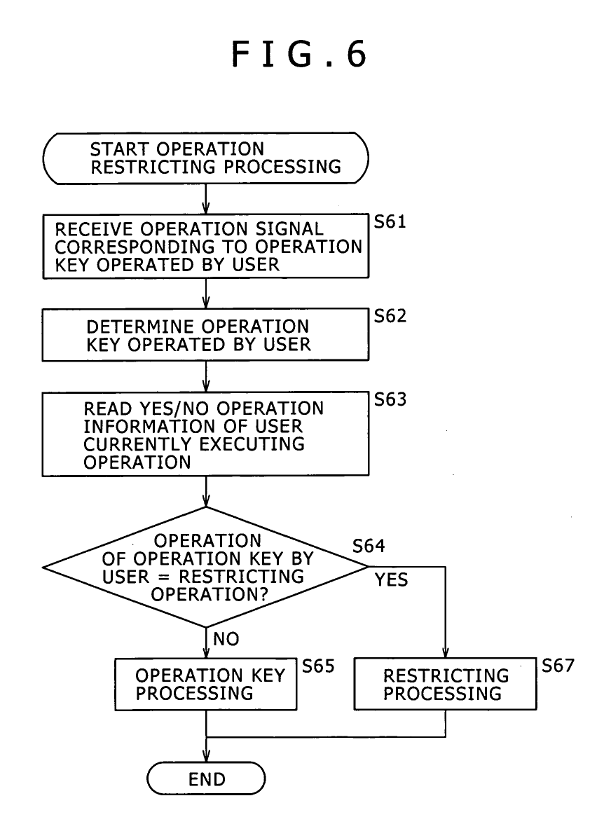

FIG. 6 shows a flowchart indicative of the operation restriction processing.

For example, if the user operates the remote commander 13 shown in FIG. 1 so as to make the television receiver 11 execute predetermined processing, the remote commander 13 transmits an operation signal corresponding to the operation done by the user. The operation signal from the remote commander 13 is received by the remote commander reception unit 64 (FIG. 1) to be supplied to the key reception block 143 (FIG. 4) of the main microcomputer 65.

In step S61, the key reception block 143 receives the operation signal supplied from the remote commander reception unit 64 and supplies the operation signal to the key decision block 144, upon which the procedure goes to step S62, in which the key decision block 144 determines the operation key of the remote commander 13 shown in FIG. 1 on the basis of the operation signal supplied from the key reception block 143 and supplies the operation key information obtained as a result of the determination, upon which the procedure goes to step S63.

In step S63, the restriction control block 145 reads, from the user information storage block 100, yes/no operation information related with operation user information indicative that the television receiver 11 is being operated, to be more specific, the yes/no operation information shown in FIG. 3 registered at second row in the user information list in FIG. 2, upon which the procedure goes to step S64, in which the restriction control block 145 determines whether the operation of an operation key by the user is a restricted operation or not on the basis of the yes/no operation information read from the user information storage block 100 and the operation key information supplied from the key decision block 144.

In step S64, if the operation of the operation key by the user is not found to be a restricted operation, the restriction control block 145 supplies the operation key information supplied from the key decision block 144 to the key event generation block 146, upon which the procedure goes to step S65, in which operation key processing for executing processing according to the operation key indicated by the operation key information is executed.

Namely, in step S65, the key event generation block 146 generates a key event in accordance with the operation key information supplied from the restriction control block 145 and supplies the generated key event to the key event processing block 147. Further; in step S65, the key event processing block 147 executes predetermined processing on the basis of the key event supplied from the key event generation block 146. Then, the operation restriction processing ends.

On the other hand, in step S64, if the restriction control block 145 determines that the operation of the operation key by the user is a restricted operation, then the procedure goes to step S67, in which restriction processing for restricting processing is executed in accordance with the operation key indicated by the operation key information.

Namely, as the restriction processing, the restriction control block 145 does not supply the operation key information to the key event generation block 146 but discards (ignores) the operation key information. Consequently, the key event generation block 146 generates no key event, so that the key event processing block 147 does not execute the processing based on a key event, thereby restricting the processing according to the operation done by the user.

Then, the operation restriction processing ends.

It should be noted that, in the restriction processing in step S67, the restriction control block 145 further can instruct the key event processing block 147 to display a message that the operation of the operation key by the user has been restricted onto the display 58 shown in FIG. 1 in OSD, for example.

In this case, on the basis of the instruction supplied from the restriction control block 145, the key event processing block 147 displays the message that the operation of the operation key by the user has been restricted onto the display 58 in OSD, for example.

Displaying such a message can prevent the user from jumping to conclusions that the television receiver 11 has gotten out of order.

As described above, on the basis of user identifier, an operating user who is operating the remote commander 13 is identified without password entry by the user and, on the basis of yes/no operation information related with the user identifier for identifying the operating user, it is determined whether the operation of the remote commander 13 by the operating user is a restricted operation or not. Then, if the operation of the remote commander 13 by the operating user is found to be a restricted operation, the processing to be executed in accordance with the operation of the remote commander 13 by the user is restricted. Further, the restricted operation includes an initializing operation for putting user information into the initial state where all operations are not restricted.

Therefore, for example, the father and mother of a home can surely restrict operations to be executed by children by not restricting the operation to be executed by the father and mother.

Namely, for example, the father and mother having no operational restriction can set the user information of children so as to restrict the initializing operation by children, thereby surely restricting children from executing the initializing operation.

Further, as a result of surely restricting the initializing operation by children, the possibility of executing the initializing operation by children to put the user information into the initial state where an operation specified restricted can be executed is prevented, thereby surely restricting any operations that are restricted operations.

Also, the father and mother having no restriction on operations thereof can execute the initializing operation without password entry to make all operations free of restriction, so that the father and mother can restrict operations to be executed by children without being afraid of losing passwords.

In addition, for example, nurslings and infants are identified to be default users unless user information is registered, so that specifying the operation of the volume button by default user as a restricted operation allows the realization of so-called child lock. Namely, by specifying the operation of the volume button by default user as a restricted operation, if a nursling or an infant that is default user keeps pressing the volume button, the operation of the volume button by a nursling or an infant that is default user is restricted (ignored), so that child lock is realized.

It should be noted that, in the present embodiment, the above-description was made assuming two or more items of user information be registered in the user information list shown in FIG. 2; however, in the initial state where only the user information of default users is registered, all users are handled as default users. Default users in this case are users free of restriction on any operation, so that, as with users having computer administrative right, the default users can register the user information in the user information list.

Also, if the power to the television receiver 11 is turned off and then turned on, the user who has operated the television receiver 11 up to a point of time immediately before the power-off is not always the who operated the television receiver 11 at the power-on, so that the user at the time of power-on of the television receiver 11 can be handled as a default user.

This can be executed, in the operating user identification block 142, when the power to the television receiver 11 has been turned off, by updating the operating user information of default user by the operating user information indicative that the television receiver 11 is being operated and the operating user information of a user other than default user by the operating user information indicative that the television receiver 11 is not being operated (unoperated), respectively.

It should be noted that, in the present description, the steps for describing each program stored in a program storage media include not only the processing operations which are sequentially executed in a time-dependent manner but also the processing operations which are executed concurrently or discretely.

It should also be noted that term a system as used herein denotes a logical set of a plurality of component units and these component units are not necessary accommodated in a same housing.

It should be noted that, in the present embodiment, if a user operates the remote commander 13 shown in FIG. 1 as a user other than default user, the user other than default user is identified as the operating user in the operating user identification processing shown in FIG. 5 and then, on the basis of yes/no operation information related with the user identifier of the user other than the identified default user, the operation restriction processing shown in FIG. 6 is executed every time the remote commander 13 shown in FIG. 1 is operated; however, it is also practicable to execute the operating user identification processing shown in FIG. 5 and the operation restriction processing shown in FIG. 6 every time the remote commander 13 shown in FIG. 1 is operated.

To be more specific, every time the remote commander 13 of the FIG. 1 is operated, an operation signal corresponding to the operation key operated by the user and the user identifier of the user who operated that operation key are supplied from the remote commander 13 to the main microcomputer 65 shown in FIG. 1. Then, on the basis of the user identifier from the remote commander 13 and the user identifier stored in the user information storage block 100, the main microcomputer 65 can execute the operating user identification processing shown in FIG. 5 and, on the basis of the yes/no operation information of the user identified by this operating user identification processing, can execute the operation restriction processing shown in FIG. 6.

It should be noted that, as described above, in the present embodiment, if the user operates the remote commander 13 shown in FIG. 1 as a user other than identified default user, a user other than default user is identified as the operating user by the operating user identification processing shown in FIG. 5 and then, on the basis of the yes/no operation information related with the user identifier of the user other than default user, the operation restriction processing shown in FIG. 6 is executed every time the remote commander 13 shown in FIG. 1 is operated; however, in this case, after a user other than default user has been identified as the operating user by the operating user identification processing shown in FIG. 5, the operating user identification processing is not executed unless the remote commander 13 is operated so as for the user to execute the operating user identification processing.

Therefore, even if a user other than default user identified by the operating user identification processing operates the remote commander 13 after a user other than default user has been identified by the operating user identification processing, the operation restriction processing is executed on the basis of the yes/no operation information related with the user identifier of the operating user identified by the operating user identification processing.

Here, for example, if, after a father or a mother having no operational restriction is identified as an operating user by the operating user identification processing, the child having operational restriction operates the remote commander 13, the operation restriction processing is executed on the basis of the yes/no operation information related with the user identifier of the father or mother having no operation restriction.

In this case, the child having operational restriction can execute the operation similar to that of the father or mother having no operation restriction. Consequently, the child having operational restriction can operate the remote commander 13 by masquerading the father or mother having no operational restriction.

On the other hand, if the operating user identification processing shown in FIG. 5 and the operation restriction processing shown in FIG. 6 is executed every time the remote commander 13 is executed, then, every time the remote commander 13 is operated, a user having operating this operation is identified, so that, even if the child having operation restriction operates the remote commander 13 after the remote commander 13 was operated by the father or mother having no operational restriction and the father or mother having no operational restriction has been identified as an operating user, the child having operational restriction is identified as an operating user by the operating user identification processing, thereby preventing the child from operating the remote commander 13 by masquerading as the father or mother having no operational restriction.

Also, in the present embodiment, user fingerprint information for example is used for user identifier; however, user identifier is not limited to this, so that any information can be used that can identify a user without password entry by the user. For example, a user-unique remote command may be prepared for each user that stores beforehand user-unique information as user identification information and, every time this remote commander is operated, the user-unique information may be transmitted to the television receiver 11.

It should be noted that, in the present embodiment, yes/no operation information indicative of a restricted operation for restricting an operation to be executed by a user is registered in the user information storage block 100 shown in FIG. 4 and it is determined on the basis of this yes/no operation information whether an operation done by the user is a restricted operation or not and, if the operation done by the user is found to be a restricted operation, the operation by the user is restricted; however, it is also practicable that the processing to be executed in accordance with a user operation is permitted by registering yes/no operation information indicative of a permitted operation permitted for a user to do and determining, on the basis of this yes/no operation information, whether the operation by the user is a permitted operation or not, thereby permitting the processing to be executed in accordance with the operation by the user if the operation by the user is found to be a permitted operation.

In this case, the initialing operation puts yes/no operation information into an initial state where all operations by the user are permitted.

It should be noted that, the restriction control block 145, as described above, if the operation of the operation key by a user is found to be a restricted operation, discards the operation key information supplied from the key decision block 144 without supplying to the key event generation block 146, thereby restricting the processing according to the restricted operation by the user; however, it is also practicable to restrict the processing according to the restricted operation by the user by controlling the key event generation block 146 and the key event processing block 147.

Namely, if the operation of the operation key by the user is found to be a restricted operation, then the restriction control block 145 controls the key event generation block 146 to prevent the key event generated in accordance with the operation key information supplied from the key decision block 144 via the restriction control block 145 from being supplied from the key event generation block 146 to the key event processing block 147, thereby restricting the processing in accordance with the restricted operation by the user.

Also, if the operation of the operation key by the user is found to be a restricted operation, the restriction control block 145 controls the key event processing unit 147 so as to discard the key event supplied from the key event generation block 146, thereby restricting the processing in accordance with the restricted operation by the user.

Here, operations that are restricted operations may include the operation of a button and a lever displayed on a menu screen in addition to the operations of the remote commander 13 and the operator unit 63. If the operation of a button or a lever displayed on a menu screen is a restricted operation, the restriction control block 145 controls the key event processing block 147 (the display control section 147a thereof) so as to display a menu screen in a state where button and levers subject to operational restriction cannot be operated and a menu screen in a state where there is no button or lever subject to operational restriction, thereby restricting the processing in accordance with the operations of these button and lever.

Further, the yes/no operation information of default user can be set (operated) by the user not restricted for the setting of yes/no operation information; in addition, the yes/no operation information of default user can be a so-called logical sum of the yes/no operation information of the user information of all users except for default user registered in the user information list shown in FIG. 2. In this case, operations that can be done by default user are limited to, so to speak, the greatest common factor operations that can be done by all users except for default users.

It should be noted that, if both the initializing operation and the yes/no operation information clearing operation of all users registered in the user information list are restricted owing to an operation by any of the users registered in the user information list, then all users registered in the user information list cannot execute the initializing operation that is a restricted operation and, at the same time, cannot clear the initializing operation from the restricted operation. As a result, the television receiver 11 is put in a registered-user initialization disabled state where an initializing operation cannot be executed by any user registered in the user information list.

Therefore, when any user registered in the user information list is attempting to execute the operation for getting in the registered-user initialization disabled state, the television receiver 11 displays a message notifying that user of a situation in which execution of the operation for getting in the registered-user initialization disabled state causes the registered-user initialization disabled state, thereby giving a warning that the registered-user initialization disabled state will be caused. Consequently, the television receiver 11 can be prevented from getting in the registered-user initialization disabled state.

It should be noted that, even if the television receiver 11 gets in the registered-user initialization disabled state, any user of the users registered in the user information list who is not registered as a user restricted to a user registering operation to register a new user can execute a user registering operation to register a new user for whom the initializing operation is not registered as a restricted operation, thereby allowing the newly registered user to execute the initializing operation.

However, if the initializing operation, the yes/no operation information clearing operation, and the user registering operation are restricted for all users registered in the user information list, any user registered in the user information list cannot execute the initializing operation and clear the restricted operations, of the initializing operation, and, further, execute the user registering operation for registering a new user for whom the initializing operation is not registered as a restricted operation. As a result, the television receiver 11 gets in a completely initialization disabled state in which the initializing operation cannot be completely executed by any means by any user registered in the user information list.

Therefore, any of the users registered in the user information list is attempting to execute an operation that causes the completely initialization disabled state, the television receiver 11 displays a message to notify that user of the causing of the completely initialization disabled state if the operation for causing the completely initialization disabled state is executed, thereby giving a warning that the completely initialization disabled state will be caused. This prevents the television receiver 11 from getting in the completely initialization disabled state.

It should be noted that the present embodiment is not limited to the embodiment mentioned above and it is to be understood that changes and variations may be made without departing from the spirit of the present invention.

1. A reception device for receiving television broadcast, comprising:
storage means for storing user identifier for identifying a user and yes/no operation information indicative of a restricted/permitted operation that is restricted or permitted for a user identified by that user identifier, said user identifier and said yes/no operation information being related with each other;
identification means for identifying, on the basis of said user identifier, an operating user who operates operation means to be operated by a user without password entry;
decision means for determining, on the basis of said yes/no operation information related with said user identifier for identifying said operating user, whether an operation of said operation means by said operating user is a restricted/permitted operation; and
processing control means for restricting or permitting processing to be executed in accordance with an operation of said operation means by said operating user if the operation of said operation means by said operating user is found by said decision means to be a restricted/permitted operation,
wherein said restricted/permitted operation includes an initializing operation for putting said yes/no operation information into an initial state indicative that all operations of said operation means are not restricted or an initial state indicative that all operations of said operation means are permitted.

2. The reception device according to claim 1, wherein said storage means stores said user identifier and said yes/no operation information as related with each other in accordance with an operation of said operation means.

3. The reception device according to claim 1, wherein said reception device is a television receiver.

4. The reception device according to claim 1, wherein said storage means stores said user identifier and setting information indicative of setting of said reception device customized for a user identified by that user identifier, said user identifier and said setting information being further related with each other,
said reception device further comprising:
setting control means for setting the setting of said reception device to the setting customized for said operating user on the basis of said setting information related with said user identifier for identifying said operating user.

5. A control method for controlling a reception device for receiving television broadcast, comprising the steps of:
identifying, on the basis of user identifier stored in storage means, an operating user who operates operation means to be operated by a user without password entry; said storage means storing said user identifier for identifying a user and yes/no operation information indicative of a restricted/permitted operation that is restricted or permitted for a user identified by that user identifier, said user identifier and said yes/no operation information being related with each other;
determining, on the basis of said yes/no operation information related with said user identifier for identifying said operating user, whether an operation of said operation means by said operating user is a restricted/permitted operation; and
restricting or permitting processing to be executed in accordance with an operation of said operation means by said operating user if the operation of said operation means by said operating user is found to be a restricted/permitted operation,
wherein said restricted/permitted operation includes an initializing operation for putting said yes/no operation information into an initial state indicative that all operations of said operation means are not restricted or an initial state indicative that all operations of said operation means are permitted.

6. A program for making a computer execute control processing for controlling a reception device for receiving television broadcast, comprising the steps of:
identifying, on the basis of user identifier stored in storage means, an operating user who operates operation means to be operated by a user without password entry; said storage means storing said user identifier for identifying a user and yes/no operation information indicative of a restricted/permitted operation that is restricted or permitted for a user identified by that user identifier, said user identifier and said yes/no operation information being related with each other;
determining, on the basis of said yes/no operation information related with said user identifier for identifying said operating user, whether an operation of said operation means by said operating user is a restricted/permitted operation; and
restricting or permitting processing to be executed in accordance with an operation of said operation means by said operating user if the operation of said operation means by said operating user is found to be a restricted/permitted operation,
wherein said restricted/permitted operation includes an initializing operation for putting said yes/no operation information into an initial state indicative that all operations of said operation means are not restricted or an initial state indicative that all operations of said operation means are permitted.
